(19) United States
(12) Patent Application Publication
(10) Pub. No.: US 2022/0304546 A1
(43) Pub. Date: Sep. 29, 2022

(54) DISH CLEANING BY DIRT LOCALIZATION AND TARGETING

(71) Applicant: Sri Rama Prasanna Pavani, San Carlos, CA (US)

(72) Inventor: Sri Rama Prasanna Pavani, San Carlos, CA (US)

(21) Appl. No.: 17/211,860

(22) Filed: Mar. 25, 2021

(51) Int. Cl. A47L 15/42; G06T 7/174; G06T 1/00; G06K 9/62; G06T 7/521; G06K 9/00; G06T 7/593; A47L 15/46; A47L 15/00

(52) U.S. Cl. CPC A47L 15/4295; G06T 7/174; G06T 1/0014; G06K 9/6256; G06T 7/521; G06K 9/00208; G06T 7/593; A47L 15/4282; A47L 15/46; A47L 15/4242; A47L 15/0089; G06T 2207/10012; G06T 2207/10048; A47L 2401/04; A47L 2501/20

(57) ABSTRACT

A system and method for cleaning a dish, comprising: capturing at least one image of said dish using at least one camera; computing a bounding polygon for a dirty region in said image, wherein said dirty region is a region of said dish containing unwanted material that needs to be removed; computing a three dimensional representation of said bounding polygon by estimating three dimensional locations of multiple points within said bounding polygon; computing a spray pattern within said three dimensional representation of said bounding polygon such that the spray pattern substantially covers all regions of said three dimensional representation; and spraying a fluid on said dirty region of said dish with a nozzle, wherein said nozzle is reoriented or relocated such that said fluid reaches at least one location within said three dimensional representation of said bounding polygon according to said spray pattern, whereby dirty regions of said dish are targeted for a fast and efficient cleaning of said dish.

### FIELD OF THE INVENTION

This invention relates generally to cleaning a dish by localizing its dirty regions and targeting the dirty regions for deep cleaning.

### BACKGROUND

Conventional dishwashers wash a large number of dishes at once. Such batch washing comes with two major problems. Firstly, when washing a large number of dishes together, conventional dishwashers prioritize the average cleanliness of a group of dishes over the thorough cleanliness of every individual dish. Conventional dishwashers typically employ a turbidity detector to measure the quantity of dirt present in water during the cleaning process. When the turbidity detector senses the dirt level to be under a threshold, conventional dishwashers assume that dishes are clean. Such an assumption arrived based on the average state of a batch of dishes often overlooks the state of each individual dish in the batch. Conventional dishwashers do not have the means to ensure every dish is thoroughly cleaned during the cleaning process. This is the reason why dishes often do not come out clean even after hours of washing in a conventional dishwasher. A slew of preparatory work such as scraping, rinsing, soaking, optimal loading and positioning of dishes according to their shape, size, and material becomes necessary to maximize the chances of dirty dishes coming out clean in a conventional dishwasher, albeit without any guarantee of success.

Secondly, conventional dishwashers found in homes are substantially slower than washing dishes by hand in a kitchen sink. Conventional dishwashers also consume much more water and energy than washing dishes by hand. This is because batch dishwashing lacks the perception and ability to focus on dirty regions of an individual dish. As a result, it spends much more resources on clean regions of dishes than what is necessary, in an attempt to maximize the chances of all dirty regions of dishes to come out clean. Batch dishwashing fundamentally suffers from a tradeoff between the duration of the dishwashing cycle and cleanliness of each dish. Without the perception to evaluate the cleanliness of each dish, batch dishwashing resorts to longer dishwashing cycles, spanning hours, to increase the chances of removing dirt from all dishes, thereby causing a significant wastage of time, energy, and water.

Accordingly, there is a need for an improved system and method to clean a dirty dish thoroughly and efficiently. One that could clean each dish with individual attention to ensure every dish comes out clean after cleaning; one that could locate dirty regions of dishes in three dimensions; one that could target dirty regions for deep cleaning; one that could conserve energy and water; and one that could be as fast as hand washing of dishes.

### SUMMARY

The invention is a system and method for cleaning a dish by localizing its dirty regions and targeting the dirty regions for deep cleaning.

In some embodiments, the invention is a system for cleaning a dish, comprising: at least one camera for capturing at least one image of said dish; a processor configured to: compute a bounding polygon for a dirty region in said image, wherein said dirty region is a region of said dish containing unwanted material that needs to be removed; compute a three dimensional representation of said bounding polygon by estimating three dimensional locations of multiple points within said bounding polygon; compute a spray pattern within said three dimensional representation of said bounding polygon such that the spray pattern substantially covers all regions of said three dimensional representation; a nozzle for spraying a fluid on said dirty region of said dish, wherein said nozzle is reoriented or relocated such that said fluid reaches at least one location within said three dimensional representation of said bounding polygon according to said spray pattern, whereby dirty regions of said dish are targeted for a fast and efficient cleaning of said dish.

In some embodiments, the invention is a method for cleaning a dish, comprising: capturing at least one image of said dish using at least one camera; computing a bounding polygon for a dirty region in said image, wherein said dirty region is a region of said dish containing unwanted material that needs to be removed; computing a three dimensional representation of said bounding polygon by estimating three dimensional locations of multiple points within said bounding polygon; computing a spray pattern within said three dimensional representation of said bounding polygon such that the spray pattern substantially covers all regions of said three dimensional representation; spraying a fluid on said dirty region of said dish with a nozzle, wherein said nozzle is reoriented or relocated such that said fluid reaches at least one location within said three dimensional representation of said bounding polygon according to said spray pattern, whereby dirty regions of said dish are targeted for a fast and efficient cleaning of said dish.

### BRIEF DESCRIPTION OF THE DRAWINGS

FIG. 1 shows a three-dimensional view of a system for dish cleaning by dirt localization and targeting, in accordance with the invention.

FIG. 2 shows another three-dimensional view of a system for dish cleaning by dirt localization and targeting, in accordance with the invention.

FIG. 3 shows a front view of a system for dish cleaning by dirt localization and targeting, in accordance with the invention.

FIG. 4 shows a right-side view of a system for dish cleaning by dirt localization and targeting, in accordance with the invention.

FIG. 5 shows a back view of a system for dish cleaning by dirt localization and targeting, in accordance with the invention.

FIG. 6 shows a left-side view of a system for dish cleaning by dirt localization and targeting, in accordance with the invention.

FIG. 7 shows a top view of a system for dish cleaning by dirt localization and targeting, in accordance with the invention.

FIG. 8 shows a bottom view of a system for dish cleaning by dirt localization and targeting, in accordance with the invention.

FIG. 9 shows a camera view 13 showing a dirty dish, in accordance with the invention.

FIG. 10 shows another camera view 14 showing a dirty dish, in accordance with the invention.

FIG. 11 shows an image of a dirty dish 6 having dirty regions 7 and mildly dirty regions 8, in accordance with the invention.

FIG. 12 shows an image of a dirty dish 6 after pre-cleaning but before targeted cleaning, in accordance with the invention.

FIG. 13 shows bounding polygons 10 surrounding dirty regions 7 of a dirty dish 6, in accordance with the invention.

FIG. 14 shows bounding polygons 10 marking the locations of dirty regions of a dirty dish 6, in accordance with the invention.

FIG. 15 shows spray patterns 11 within bounding polygons 10 surrounding dirty regions of a dirty dish, in accordance with the invention.

FIG. 16 shows a method for cleaning a dish, in accordance with the invention.

### DETAILED DESCRIPTION OF THE PREFERRED EMBODIMENTS

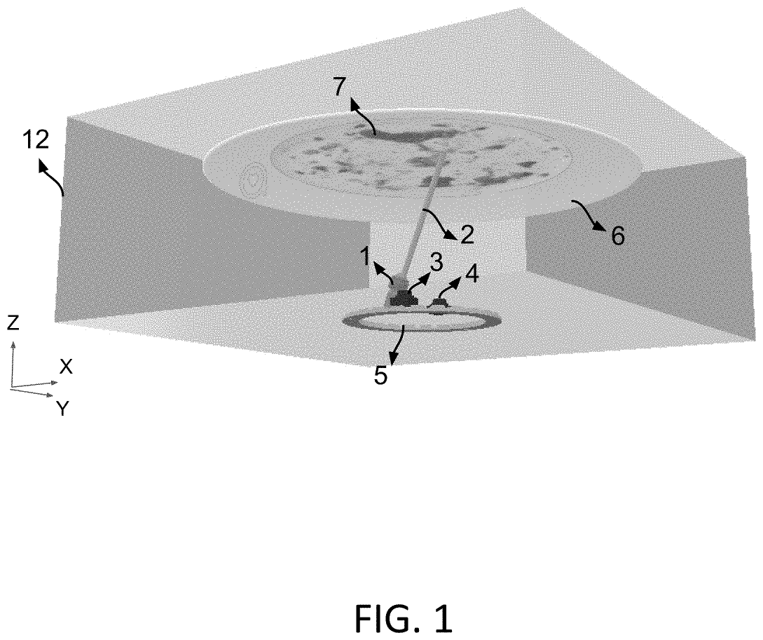

FIG. 1 shows a three-dimensional view of a system for dish cleaning by dirt localization and targeting, in accordance with the invention. A dish 6 is stained with dirty regions 7 that need to be cleaned. A dish is an article that makes contact with a food or a drink while preparing, serving, consuming, or storing of the food or the drink. Dirty regions 7 comprise unwanted material such as leftover food, dust, germs or any organic matter that need to be removed.

A light source 5 illuminates dish 6, while cameras 3 and 4 capture one or more images of dish 6. A nozzle 1 sprays a fluid on dish 6 with a predetermined spray distribution 2. Fluids include liquids and gases such as water, soap, rinsing agent, sanitizing agent, cleaning agent, or air. The nozzle 1 can reorient or relocate to spray fluid on any region of dish 6 visible in one or more images captured by cameras 3 and 4.

A processor configured to compute a bounding polygon 10 for a dirty region in a camera image. A three dimensional representation of the bounding polygon 10 is then computed by estimating three dimensional locations of multiple points within the bounding polygon 10. A spray pattern 11 within the three dimensional representation of the bounding polygon 10 is computed such that the spray pattern 11 substantially covers all regions of the three dimensional representation. In some embodiments, the bounding polygon 10 fully encompasses the dirty region in a camera image.

In some embodiments, a bounding polygon 10 is computed from the edges of the dirty region 7 of dish 6. In some embodiments, each edge of the bounding polygon 10 is substantially parallel to its closest edge of dirty region 7. In some embodiments, the bounding polygon 10 is computed by computing multiple feature points along the edges of the dirty region 7 of dish 6. In some embodiments, feature points along edges are points that are substantially different from at least some of its surrounding regions.

In some embodiments, the bounding polygon 10, the three dimensional representation, or the spray pattern 11 is estimated using a deep learning model such as a neural network. In some embodiments, a deep learning model takes a camera image of a dish as an input and returns one or more bounding polygon 10 as output. In some embodiments, a deep learning model is trained with multiple camera images and their corresponding bounding polygons 10.

In some embodiments, a deep learning model takes a camera image of a dish as an input and returns a three dimensional representation as output. In some embodiments, a deep learning model is trained with multiple camera images and their corresponding three dimensional representations. In some embodiments, a deep learning model takes a bounding polygon 10 as an input and returns a three dimensional representation as output. In some embodiments, a deep learning model is trained with multiple bounding polygons 10 and their corresponding three dimensional representations.

In some embodiments, a deep learning model takes a camera image of a dish as an input and returns a spray pattern 11 as output. In some embodiments, a deep learning model is trained with multiple camera images and their corresponding spray patterns 11. In some embodiments, a deep learning model takes a three dimensional representation as an input and returns a spray pattern 11 as output. In some embodiments, a deep learning model is trained with multiple three dimensional representations and their corresponding spray patterns 11. In some embodiments, a deep learning model takes a bounding polygon 10 as an input and returns a spray pattern 11 as output. In some embodiments, a deep learning model is trained with multiple bounding polygons 10 and their corresponding spray patterns 11.

In some embodiments, the three dimensional locations of multiple points within the bounding polygon 10 are computed from a depth map of dish 6. In some embodiments, the depth map is estimated using stereo matching from at least two camera images. In some embodiments, the depth map is estimated by projecting a structured illumination pattern on the dish, recording an image of dish 6 with said camera, computing deformations to the illumination pattern from the image, and estimating depth map from said deformations. In some embodiments, the three dimensional locations are computed by estimating the location of the bounding polygon 10 within a known three dimensional model of dish 6. In some embodiments, spray pattern 11 comprises a plurality of waypoints such that each waypoint corresponds to a specific position or orientation of nozzle 1.

The nozzle 1 sprays a fluid 2 on the dirty region 7 of dish 6. The nozzle 1 is reoriented or relocated such that the fluid reaches at least one location within the three dimensional representation of the bounding polygon 10 according to the spray pattern 11. Accordingly, dirty regions of said dish are targeted for a fast and efficient cleaning of said dish. The dish 6, nozzle 1, cameras 3 and 4, and light source 5 are enclosed in a module 12.

In some embodiments, a processor is further configured to compute a plurality of bounding polygon 10 for a plurality of dirty regions in a camera image. In some embodiments, a processor then computes a plurality of three dimensional representations of the plurality of bounding polygon 10. Further, in some embodiments, a processor computes a plurality of spray patterns 11 within the plurality of three dimensional representations.

Some embodiments comprise a light source for illuminating the dish 6. In some embodiments, the light source emits a structured pattern of light such as dots or lines. In some embodiments, the light source is either configured as a ring that surrounds a camera or configured as a diffuse illumination panel. In some embodiments, the light source emits infrared light. Some embodiments further comprise an ultraviolet light source to disinfect dish 6.

In some embodiments, a camera is designed to capture infrared images. In some embodiments, a camera captures images when a dish is placed and is ready for cleaning.

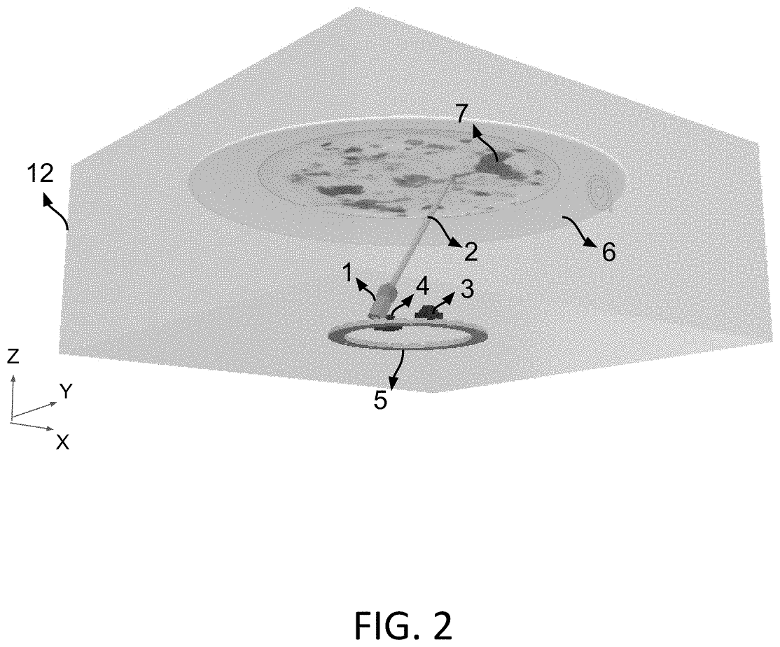

FIG. 2 shows another three-dimensional view of a system for dish cleaning by dirt localization and targeting, in accordance with the invention.

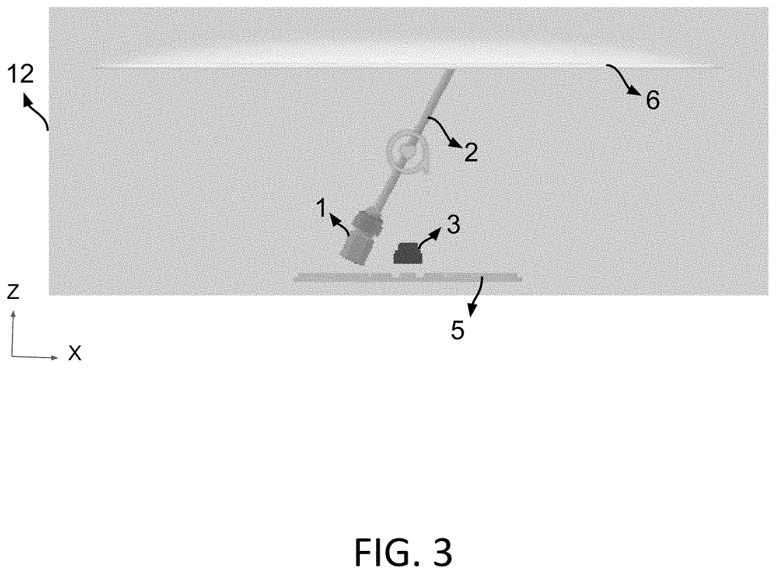

FIG. 3 shows a front view of a system for dish cleaning by dirt localization and targeting, in accordance with the invention.

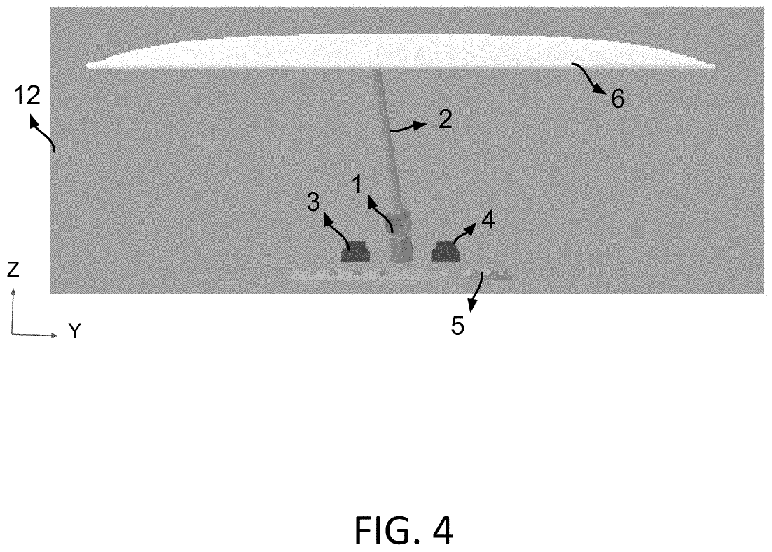

FIG. 4 shows a right-side view of a system for dish cleaning by dirt localization and targeting, in accordance with the invention.

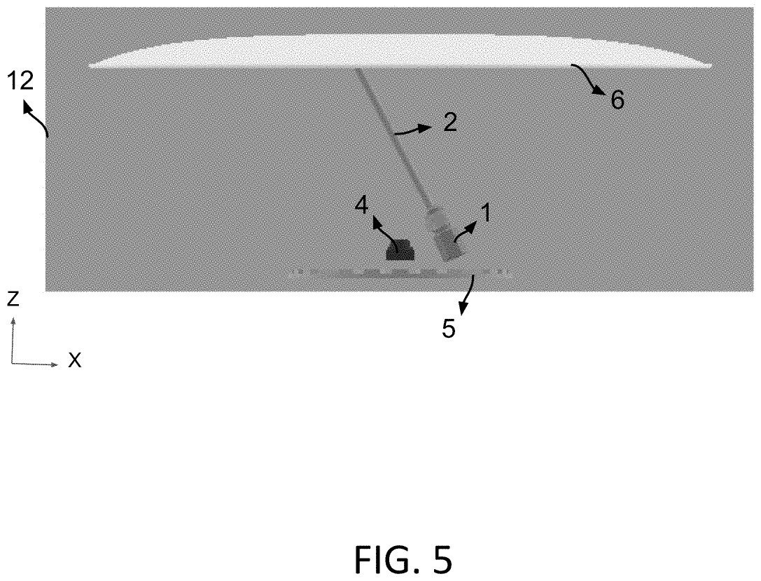

FIG. 5 shows a back view of a system for dish cleaning by dirt localization and targeting, in accordance with the invention.

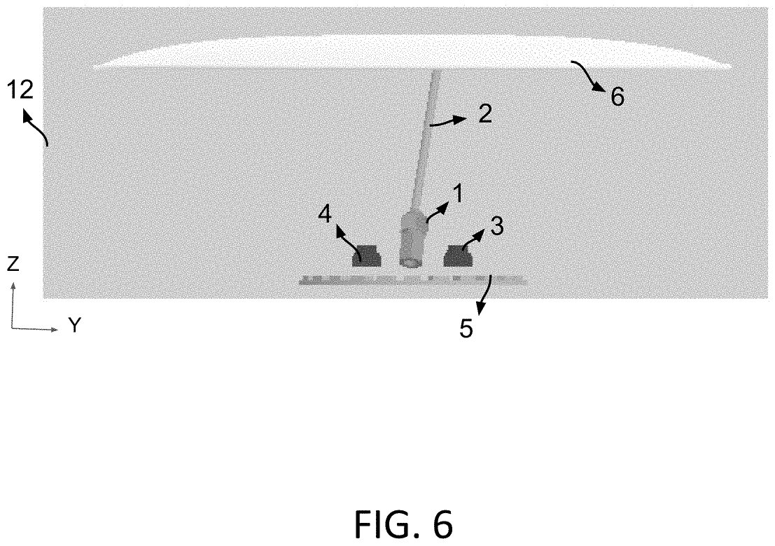

FIG. 6 shows a left-side view of a system for dish cleaning by dirt localization and targeting, in accordance with the invention.

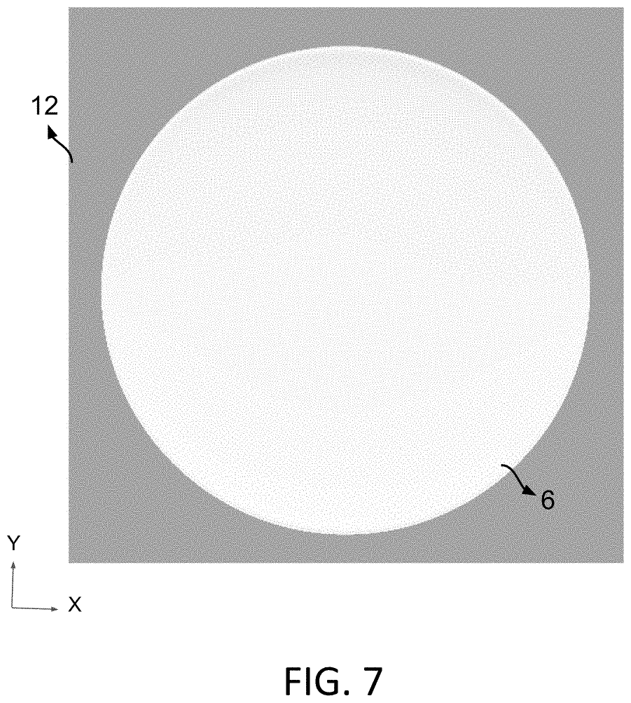

FIG. 7 shows a top view of a system for dish cleaning by dirt localization and targeting, in accordance with the invention.

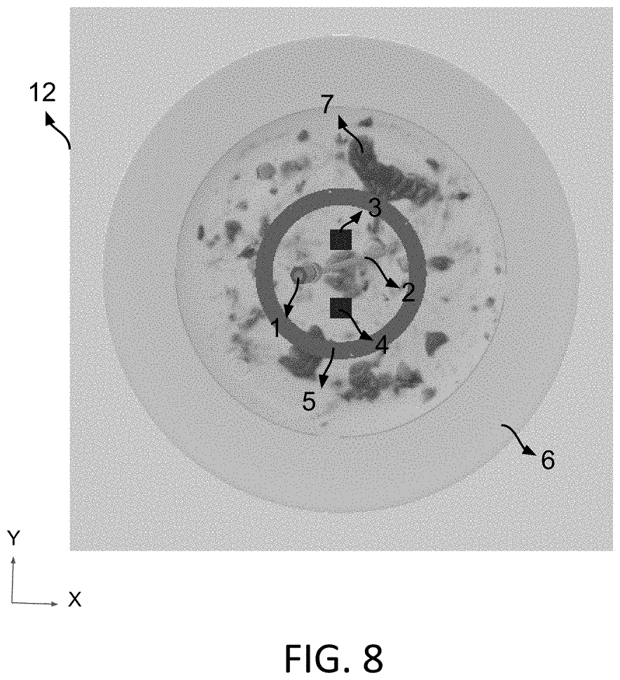

FIG. 8 shows a bottom view of a system for dish cleaning by dirt localization and targeting, in accordance with the invention.

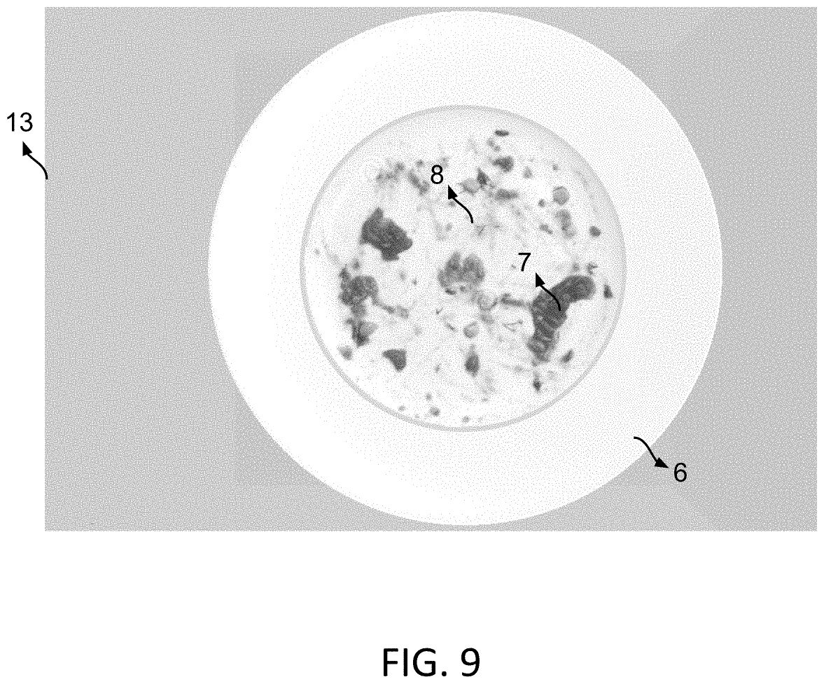

FIG. 9 shows a camera view 13 showing a dirty dish, in accordance with the invention.

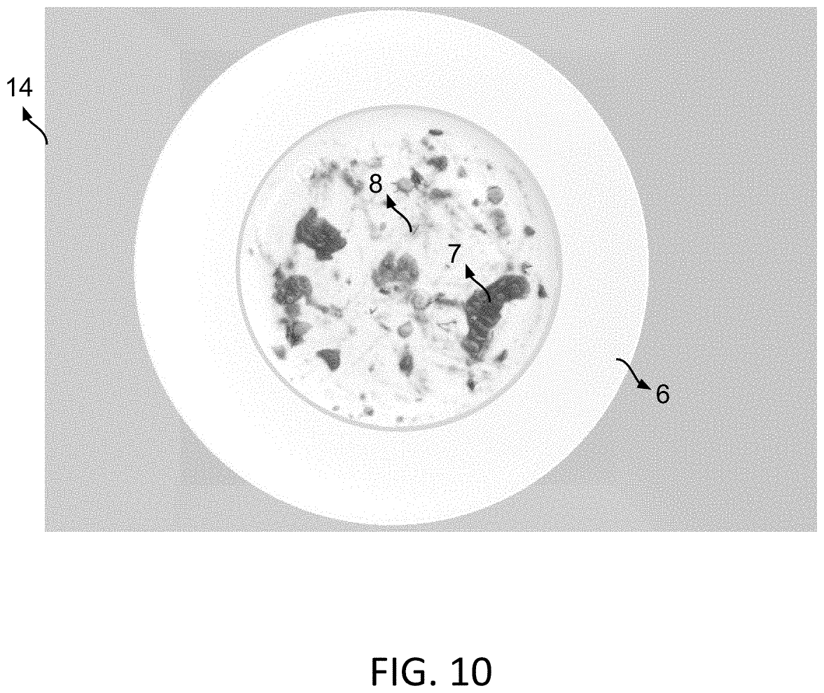

FIG. 10 shows another camera view 14 showing a dirty dish, in accordance with the invention.

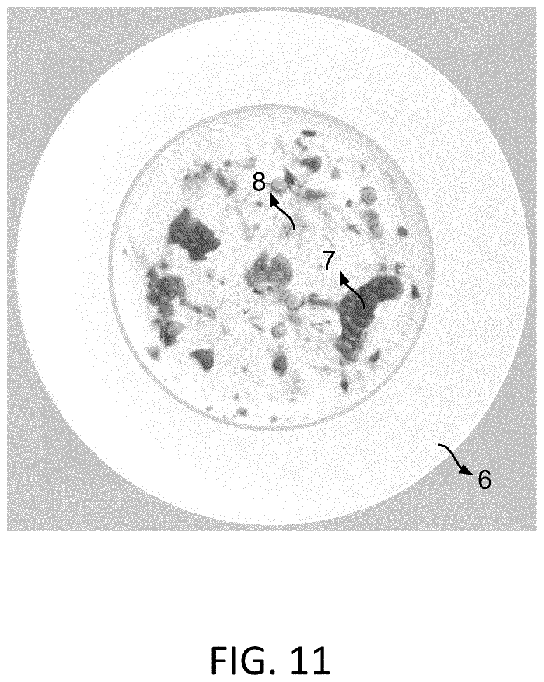

FIG. 11 shows an image of a dirty dish 6 having dirty regions 7 and mildly dirty regions 8, in accordance with the invention.

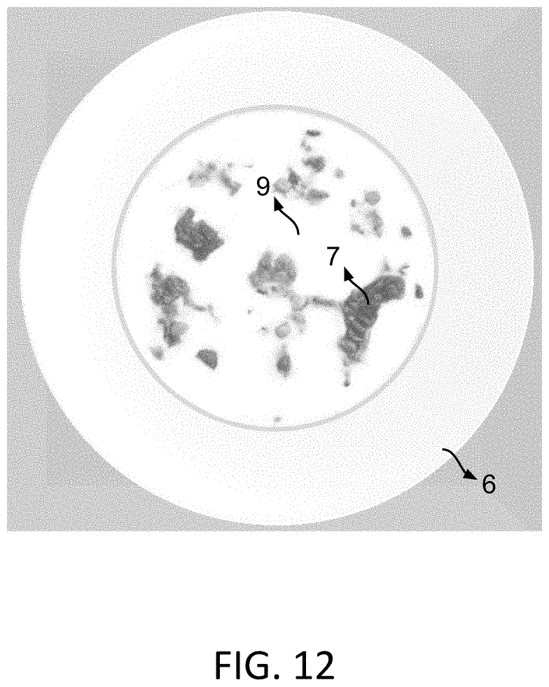

FIG. 12 shows an image of a dirty dish 6 after pre-cleaning but before targeted cleaning, in accordance with the invention. In some embodiments, pre-cleaning involves cleaning dish 6 with a fluid. In some embodiments, pre-cleaning cleans mildly dirty regions 9 but does not clean dirty regions 7.

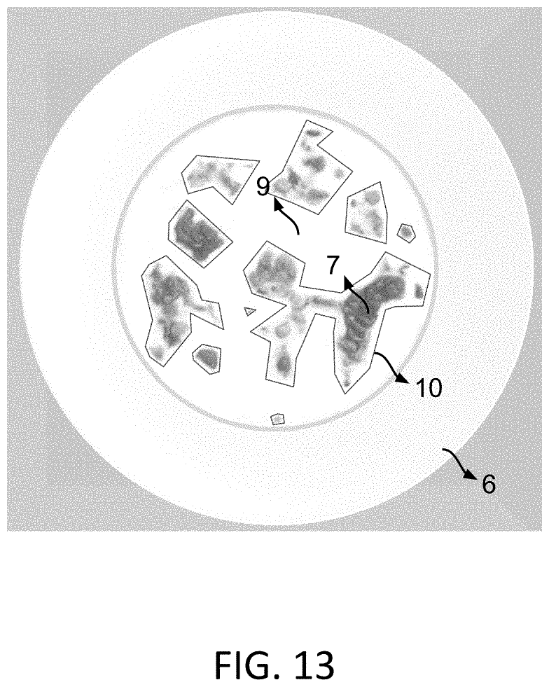

FIG. 13 shows bounding polygons 10 surrounding dirty regions of a dirty dish, in accordance with the invention.

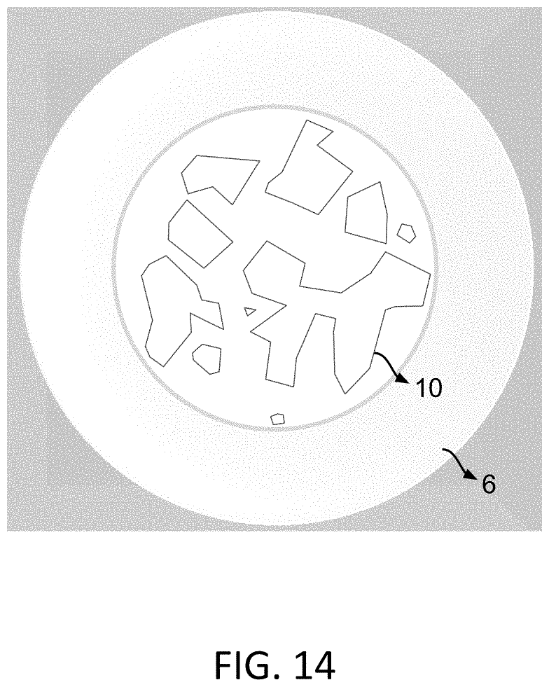

FIG. 14 shows bounding polygons 10 marking the locations of dirty regions of a dirty dish, in accordance with the invention.

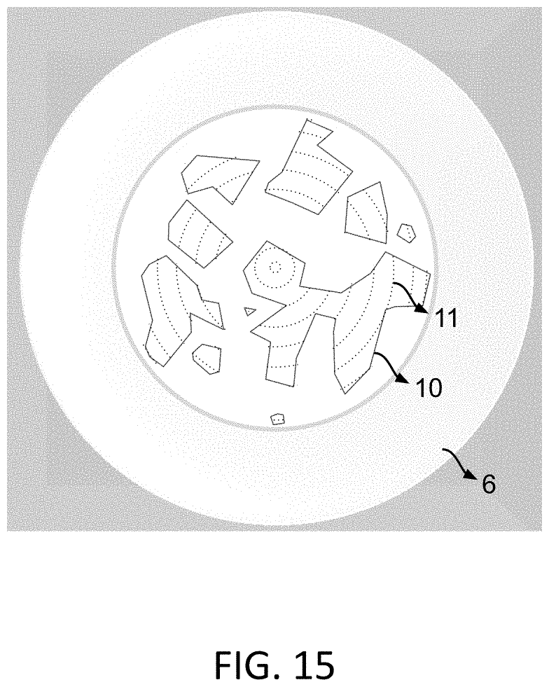

FIG. 15 shows spray patterns 11 within bounding polygons 10 surrounding dirty regions of a dirty dish, in accordance with the invention.

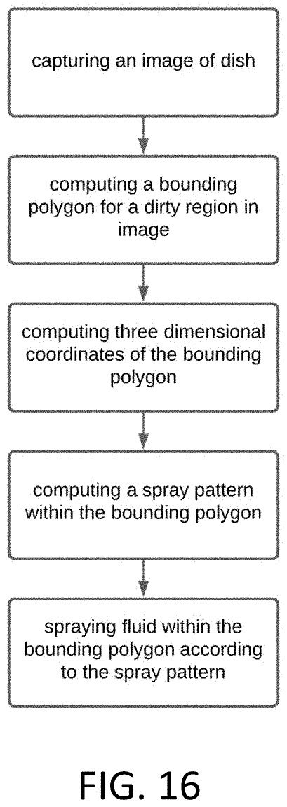

FIG. 16 shows a method for cleaning a dish, in accordance with the invention. The method comprises a series of steps. The first step involves capturing at least one image of said dish using at least one camera. The second step involves computing a bounding polygon 10 for a dirty region in a camera image. A dirty region is a region of a dish containing unwanted material that needs to be removed. The third step involves computing a three dimensional representation of the bounding polygon 10 by estimating three dimensional locations of multiple points within the bounding polygon 10. The fourth step involves computing a spray pattern 11 within the three dimensional representation of the bounding polygon 10 such that the spray pattern 11 substantially covers all regions of the three dimensional representation. The fifth step involves spraying a fluid on the dirty region of the dish with a nozzle, wherein the nozzle is reoriented or relocated such that the fluid reaches at least one location within the three dimensional representation of the bounding polygon 10 according to the spray pattern 11.

What is claimed is:

1. A system for cleaning a dish, comprising:
a. at least one camera for capturing at least one image of said dish;
b. a processor configured to:
i. compute a bounding polygon for a dirty region in said image, wherein said dirty region is a region of said dish containing unwanted material that needs to be removed;
ii. compute a three dimensional representation of said bounding polygon by estimating three dimensional locations of multiple points within said bounding polygon;
iii. compute a spray pattern within said three dimensional representation of said bounding polygon such that the spray pattern substantially covers all regions of said three dimensional representation; and
c. a nozzle for spraying a fluid on said dirty region of said dish, wherein said nozzle is reoriented or relocated such that said fluid reaches at least one location within said three dimensional representation of said bounding polygon according to said spray pattern,
whereby dirty regions of said dish are targeted for a fast and efficient cleaning of said dish.

2. The system of claim 1, wherein said processor is further configured to compute a plurality of bounding polygons for a plurality of dirty regions in said image; compute a plurality of three dimensional representations of said plurality of bounding polygons; compute a plurality of spray patterns within said plurality of three dimensional representations.

3. The system of claim 1, further comprising a light source for illuminating said dish.

4. The system of claim 3, wherein said light source emits a structured pattern of light such as dots or lines.

5. The system of claim 3, wherein said light source is either configured as a ring that surrounds a camera or configured as a diffuse illumination panel.

6. The system of claim 3, wherein said light source emits infrared light and said camera is designed to capture infrared images.

7. The system of claim 1, wherein said camera captures images when a dish is placed and is ready for cleaning.

8. The system of claim 1, further comprising an ultraviolet light source to disinfect said dish.

9. The system of claim 1, wherein said bounding polygon is computed from the edges of said dirty region of said dish.

10. The system of claim 9, wherein each edge of said bounding polygon is substantially parallel to its closest edge of said dirty region of said dish.

11. The system of claim 1, wherein the said bounding polygon is computed by computing multiple feature points along the edges of said dirty region of said dish, wherein said feature points are substantially different from at least some of its surrounding regions.

12. The system of claim 1, wherein said unwanted material in said dirty region is leftover food, dust, germs or any organic matter.

13. The system of claim 1, wherein said bounding polygon fully encompasses said dirty region in said image.

14. The system of claim 1, wherein said bounding polygon, said three dimensional representation or said spray pattern is estimated using a deep learning model.

15. The system of claim 1, wherein said three dimensional locations are computed from a depth map of said dish.

16. The system of claim 15, wherein said depth map is estimated using stereo matching from at least two camera images.

17. The system of claim 15, wherein said depth map is estimated by projecting a structured illumination pattern on said dish, recording an image of said dish with said camera, computing deformations to said illumination pattern from said image, and estimating depth map from said deformations.

18. The system of claim 1, wherein said three dimensional locations are computed by estimating the location of said bounding polygon within a known three dimensional model of said dish.

19. The system of claim 1, wherein said spray pattern comprises a plurality of waypoints such that each waypoint corresponds to a specific position or orientation of said nozzle.

20. A method for cleaning a dish, comprising:
a. capturing at least one image of said dish using at least one camera;
b. computing a bounding polygon for a dirty region in said image, wherein said dirty region is a region of said dish containing unwanted material that needs to be removed;
c. computing a three dimensional representation of said bounding polygon by estimating three dimensional locations of multiple points within said bounding polygon;
d. computing a spray pattern within said three dimensional representation of said bounding polygon such that the spray pattern substantially covers all regions of said three dimensional representation; and
e. spraying a fluid on said dirty region of said dish with a nozzle, wherein said nozzle is reoriented or relocated such that said fluid reaches at least one location within said three dimensional representation of said bounding polygon according to said spray pattern,
whereby dirty regions of said dish are targeted for a fast and efficient cleaning of said dish.
